(19) United States
(12) Patent Application Publication
(10) Pub. No.: US 2026/0291063 A1
(43) Pub. Date: Sep. 24, 2026

(54) PHASED ARRAY ANTENNA FOR ISOLATION IMPROVING AMONG PORTS

(71) Applicant: AGENCY FOR DEFENSE DEVELOPMENT, Daejeon (KR)

(72) Inventors: Ki Chul KIM, Daejeon (KR); Kyoungyoul PARK, Daejeon (KR); Jihaeng CHO, Daejeon (KR); Byeongjae KIM, Daejeon (KR); Kimin HWANG, Daejeon (KR)

(21) Appl. No.: 19/234,710

(22) Filed: Jun. 11, 2025

(30) Foreign Application Priority Data
Mar. 18, 2025 (KR) 10-2025-0034877

(51) Int. Cl. H01Q 3/36

(52) U.S. Cl. CPC H01Q 3/36

(57) ABSTRACT

Disclosed is a phased array antenna including: a substrate; a first antenna connected to one side of the substrate, and transmitting or receiving a signal to a first transmission line through a first port; a second antenna separated from the first antenna by a predetermined spacing, and connected to one side of the substrate, and transmitting or receiving a signal to a second transmission line through a second port; and a first slow-wave transmission line additionally implemented in the first transmission line of the first port, and generating a phase difference of a specific angle between a phase of the signal transmitted by the first antenna or received through the first antenna, and a phase of the signal transmitted or received through the second transmission line.

### CROSS-REFERENCE TO RELATED APPLICATION

This application claims priority to and the benefit of Korean Patent Application No. 10-2025-0034877 filed with the Korean Intellectual Property Office on Mar. 18, 2025, the entire contents of which are incorporated herein by reference.

### BACKGROUND

### (a) Field

The present disclosure relates to a phased array antenna capable of electronic beam steering, and particularly, a phased array antenna for improving isolation among ports.

### (b) Description of the Related Art

Phased array antennas, which are often used for radar, mostly operate between a C band and an X band. At a frequency of 10 GHz or less, a length of a frequency wavelength is relatively longer than a frequency wavelength of another frequency band, so that a separation distance between antennas is ensured to some extent, and as a result, isolation among antenna ports is not a big problem.

However, as many systems are being developed and there are no remaining frequencies for the systems to use in a lower frequency band, systems have been increasingly developed that operate in higher frequency bands. However, the systems operating in the high frequency bands, result in narrowing a spacing between the phased array antenna.

The reason why the spacing between the phased array antennas becomes narrower when the frequency band to be used by the system becomes higher is that the spacing between antennas needs to be about 0.5*2 for power combining of the phased array antennas. Here, λ means a frequency wavelength.

Such a narrowing of the antenna-to-antenna spacing causes coupling between the antennas, and the coupling causes inter-antenna interference. In order to reduce the inter-antenna interference, techniques for improving isolation among ports of the phased array antenna have been studied.

In addition, in recent years, in a satellite communication system for space in which a stable operation is required, a phased array antenna of a brick-type structure has been developed due to issues of heat generation and an arrangement space of a power amplifier and a low noise amplifier connected to an antenna front end. That is, a phased array antenna for satellite communications that uses a frequency higher than or equal to a Ka band should be implemented with a brick-type structure instead of a planar-type structure.

However, in the phased array antenna of the brick-type structure operating at the frequency higher than or equal to the Ka band, the spacing of ports between the antennas becomes close, and coupling occurs due to the close spacing of the ports. Accordingly, there is a need for a technique that can improve the isolation among the antenna ports in the brick-type structure in order to reduce the coupling.

### SUMMARY

Therefore, the present disclosure attempts to provides a phased array antenna for improving isolation among signal lines, i.e., among ports, of a phased array antenna of a brick-type structure.

In order to achieve the technical object, an embodiment of the present disclosure provides a phased array antenna including: a substrate; a first antenna connected to one side of the substrate, and transmitting or receiving a signal to a first transmission line through a first port; a second antenna separated from the first antenna by a predetermined spacing, and connected to one side of the substrate, and transmitting or receiving a signal to a second transmission line through a second port; and a first slow-wave transmission line additionally implemented in the first transmission line of the first port, and generating a phase difference of a specific angle between a phase of the signal transmitted by the first antenna or received through the first antenna, and a phase of the signal transmitted or received through the second transmission line.

The phased array antenna may further include: a first amplifier connected to the first transmission line, and amplifying the signal received from the first antenna or the signal to be transmitted through the first antenna; and a second amplifier connected to the second transmission line, and amplifying the signal received from the second antenna or the signal to be transmitted through the second antenna.

The phased array antenna may further include a second slow-wave transmission line implemented at one side of the second amplifier, and generating a phase difference of a specific angle from a phase of a signal transmitted and received through the first transmission line to which the first amplifier is connected.

In-phases of signals input through the first port and the second port may be adjusted based on the second slow-wave transmission line.

The first slow-wave transmission line may be implemented with a length of 10 mm, and a spacing between the first antenna and the second antenna may be any one spacing of 5 mm or 6 mm.

In order to achieve the technical object, another exemplary embodiment of the present disclosure provides a phased array antenna including: a first antenna module having a plurality of first antennas connected to a substrate through respective ports to transmit and receive signals; and a second antenna module implemented adjacent to the first antenna module, and having a plurality of second antennas connected to the substrate through respective ports to transmit and receive signals, in which a plurality of slow-wave transmission lines are included in each of the first antenna module and the second antenna module so that a phase difference between the signals transmitted and received through the first antenna module and the second antenna module becomes a specific angle.

In the first antenna module, the slow-wave transmission lines may be provided in respective ports of 2n−1-th antennas among the plurality of first antennas.

The first antenna module may include a plurality of amplifiers connected to the first transmission line, and amplifying the signal received from the plurality of first antennas or the signal to be transmitted through the first antennas, and the slow-wave transmission lines may be provided at one side of each of amplifiers located at a 2n-th position among the plurality of amplifiers.

In the second antenna module, the slow-wave transmission lines may be provided in respective ports of 2n-th antennas among the plurality of second antennas.

The second antenna module may include a plurality of amplifiers connected to the second transmission line, and amplifying the signal received from the plurality of second antennas or the signal to be transmitted through the second antennas, and the slow-wave transmission lines may be provided at one side of amplifiers located at a 2n−1-th position among the plurality of amplifiers.

In order to achieve the technical object, yet another exemplary embodiment of the present disclosure provides a phased array antenna including: a substrate; a plurality of antennas connected to one side of the substrate, and transmitting or receiving signals to or from transmission lines through a plurality of ports, respectively; and a phase shifter generating a phase difference of a specific angle between a phase of a signal transmitted or received through 2n−1-th antennas among the plurality of antennas, and a phase of a signal transmitted or received through 2n-th antennas.

The phased array antenna may further include: a first amplifier amplifying the signal received through the 2n−1-th antennas; and a second amplifier amplifying the signal received through the 2n-th antennas, and the phase shifter may adjust a phase of a signal transferred to the second amplifier to generate the phase difference of the specific angle from a phase of a signal transferred to the first amplifier.

Therefore, according to embodiments of the present disclosure, a slow-wave transmission line can be applied to a phased array antenna, so as to generate a phase difference at the same size without changing the size of the phased array antenna.

In addition, by improving isolation among ports by generating a phase difference between adjacent transmission lines, coupling between transmission lines can be reduced.

In addition, the reduction in coupling can prevent a desired phase value from changing due to mutual signal interference when all active elements operate simultaneously.

In addition, the slow-wave transmission line structure is applied to a front end of an amplifier, so that the in-phases of signals input from respective ports can be adjusted to be the same.

Further, the signals of the ports adjusted with in phase for each port can be synthesized with each other to generate a signal of a magnitude required in a satellite communication system for space.

Further, the phased array antenna can preserve a phase value, so that a direction of a beam to be directed can be generated without an error.

### BRIEF DESCRIPTION OF THE DRAWINGS

FIG. 1 is an exemplary diagram of a general phased array antenna.

FIG. 2 is an exemplary diagram of a phased array antenna according to an embodiment of the present disclosure.

FIG. 3 is an exemplary diagram of a substrate according to an embodiment of the present disclosure.

FIGS. 4 and 5 are exemplary diagrams illustrating simulation results according to an embodiment of the present disclosure.

FIG. 6 is an exemplary diagram of a phased array antenna according to another exemplary embodiment of the present disclosure.

### DETAILED DESCRIPTION OF THE EMBODIMENTS

In the following detailed description, only certain embodiments of the present disclosure have been shown and described, simply by way of illustration. The present disclosure can be variously implemented and is not limited to the following embodiments.

The drawings and description are to be regarded as illustrative in nature and not restrictive. Like reference numerals designate like elements throughout the specification.

In addition, throughout this specification, unless explicitly described to the contrary, the word “comprise”, and variations such as “comprises” or “comprising”, will be understood to imply the inclusion of stated elements but not the exclusion of any other elements.

Hereinafter, a phased array antenna for improving isolation among ports according to an embodiment of the present disclosure will be described in detail with reference to drawings. Prior to the exemplary embodiment of the present disclosure, a generally phased array antenna will be first described.

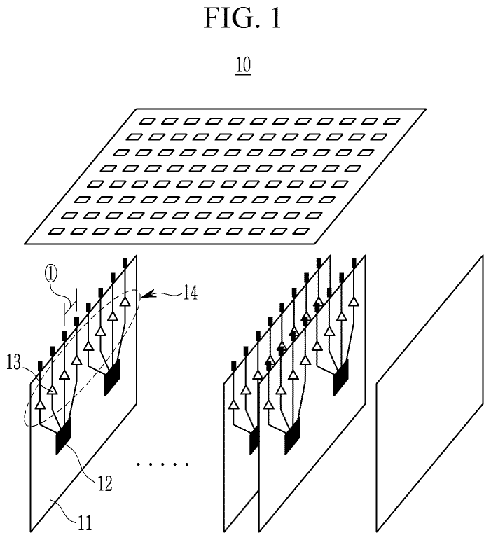

FIG. 1 is an exemplary diagram of a general phased array antenna.

In order to perform electronic beam steering, the phased array antenna receives, as inputs, different amplitudes and phase values respectively determined for each antenna port by a controller (not illustrated). Different input values per port should each be kept at a unique value. However, when isolation among ports is low, coupling occurs among the ports, and the unique value that needs to be maintained for each port is changed to another value.

A change in the unique value, which needs to be maintained for each port, results in a misalignment of a beam directing angle, which becomes a cause of an error for the phased array antenna. In order to reduce such an error, the isolation among the ports of the phased array antenna is important.

Here, the isolation among the ports is also closely related to the frequency used by the phased array antenna. That is, as the frequency band used by the phased array antenna corresponds to a higher frequency band, the spacing between the ports of the phased array antenna becomes narrower. In addition, the narrowed spacing between the ports causes deterioration of the coupling between the ports.

As the spacing between the ports becomes narrower, issues may arise with respect to a placement space of an amplifier (e.g., a power amplifier or a low noise amplifier, etc.) connected to the front end of the antenna. As a result, as illustrated in FIG. 1, the phased array antenna of the brick-type structure is mainly used in the satellite communication system for space. The brick-type phased array antenna is an antenna that uses a plurality of planar substrates (hereinafter, also referred to as “control boards”) on which a plurality of elements are mounted.

In FIG. 1, it is described as an example that a four-channel beamforming IC 12 is implemented on the control board 11 of the phased array antenna 10. In addition, an amplifier 13 for an amplification function of a transmission signal and a reception signal, such as a power amplifier for the transmission signal or a low noise amplifier for the reception signal, is mounted for each channel.

At this time, a general phased array antenna 10 has an inter-port spacing (1) of about 0.5 cm in the Ka band. Due to a narrow inter-port spacing of 0.5 cm, coupling 14 occurs between the antennas. As a result, phase information of a desired signal is distorted for each port, so that the accuracy of the electronic beam steering is poor, and the performance of the phased array antenna is not ensured.

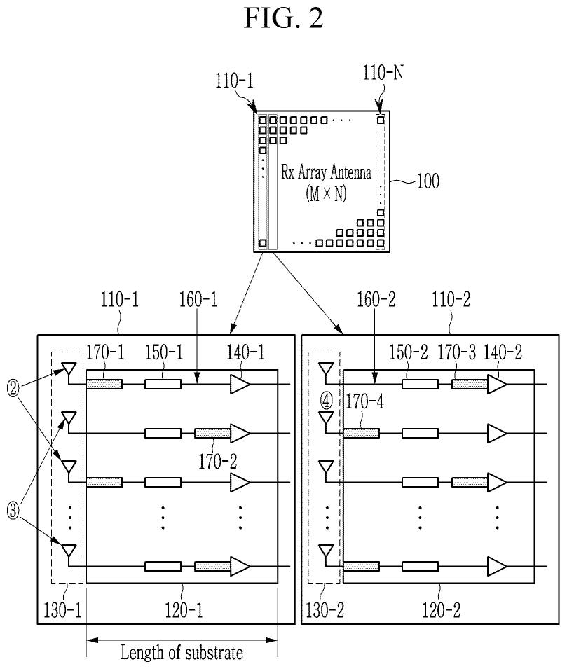

Therefore, in the embodiment of the present disclosure, a coupling influence between the antennas is canceled or minimized, so as to improve the inter-port isolation. This will be described with reference to FIG. 2. In the embodiments of the present disclosure, it is described that the isolation among the ports is improved for convenience of description, but the meaning may be understood as isolation among signal lines, or isolation among antennas.

FIG. 2 is an exemplary diagram of a phased array antenna according to an embodiment of the present disclosure.

As illustrated in FIG. 2, the phased array antenna 100 includes a plurality of antenna modules 110 (110-1 to 110-N). In addition, various components necessary for the operation of the phased array antenna 100, such as a controller (not illustrated) for calculating an amplitude and a phase value input for each antenna port, may be further included in an antenna system including the phased array antenna 100.

Each antenna module 110 has a plurality of antennas 130-1 and 130-2 connected to one end of each of substrates 120-1 and 120-2.

In the embodiment of the present disclosure, only the first antenna module 110-1 and the second antenna module 110-2 of the N antenna modules 110 constituting the brick-type phased array antenna 100 are illustrated for convenience of description. In addition, in each antenna module 110, M antennas 130-1 and 130-2 are connected to the substrates 120-1 and 120-2, and ports are formed in the substrates 120-1 and 120-2 to which the antennas 130-1 and 130-2 are connected, respectively. In the embodiment of the present disclosure, only four antennas are illustrated and described for convenience of description.

In addition, in each antenna module 110, respective filters 150 (150-1 and 150-2) are respectively connected to the antennas 130 (130-1 and 130-2) via transmission lines (hereinafter referred to as “general transmission lines”) 160 (160-1 and 160-2). Further, in each filter 150, opposite sides not connected to the antennas 130-1 and 130-2 are connected to the amplifiers 140 (140-1 and 140-2) via the general transmission line 160. Such a filter 150 may be included in the phased array antenna 100 or removed from the phased array antenna 100 according to a need of the phased array antenna 100.

In the embodiment of the present disclosure, the type of general transmission line 160 is not limited to any one. In addition, in the embodiment of the present disclosure, it is described as an example that the amplifier 140 is a low noise amplifier (LNA).

Some ports in each antenna module 110 further include transmission lines of a slow-wave structure (hereinafter, referred to as “slow-wave transmission lines” for convenience of description) 170 (170-1, 170-2, 170-3, and 170-4).

Adding the slow-wave transmission line 170 means connecting the slow-wave transmission line to the general transmission line 160. That is, a shape of the substrate 120 to which the general transmission line 160 is grounded is transformed, which may serve as the transmission line of the slow-wave structure.

Here, the slow-wave transmission line means a transmission line for transmitting a signal wave at a lower speed than the general transmission line 160. A difference in speed of the signal wave means that a phase difference occurs.

Therefore, the slow-wave transmission line 160 is reflected with a predetermined length in order to give a desired phase difference for each frequency. As one example, when it is assumed that a phase difference is 10 degrees/10 mm and it is assumed that a desired phase difference is 180 degrees, reflection of a 180 mm long slow-wave transmission line 160 is required.

In the phased array antenna 100, the first antenna module 110-1 has a structure in which the slow-wave transmission line 170-1 is connected to a port at an end of the substrate 120-1 connected to specific antennas (2). In the embodiment of the disclosure, it is described as an example that the slow-wave transmission line 170-1 is connected to ports to which odd-numbered antennas (2) of the first antenna module 110-1 are connected, but the slow-wave transmission line 170-1 may be connected to a port of an even-numbered antenna.

As described above, it is described as an example that the port to which the slow-wave transmission line 170-1 is connected is not connected to a port of each of all the antennas 130-1, but is alternately connected to the slow-wave transmission lines 170-1, such as any one of the odd-numbered port or the even-numbered port.

Through a structure in which the slow-wave transmission line 170-1 is connected to a port of a specific antenna (2), a phase change amount between ports by coupling between the general transmission line 160-1 and the slow-wave transmission line 170-1 may be reduced. Further, by using the slow-wave transmission line 170-1, a phase difference between the slow-wave transmission line 170-1 and the general transmission line 160-1 may be generated as 180 degrees, thereby improving the isolation among the ports.

In order to generate the phase difference between the general transmission line 160-1 and the slow-wave transmission line 170-1 as 180 degrees, a length of the slow-wave transmission line 170-1 of the substrate 120-1 is implemented as 10 mm in the embodiment of the present disclosure. However, for a length which makes the phase difference between the general transmission line 160-1 and the slow-wave transmission line 170-1 be 180 degrees, a length of the slow-wave transmission line 170-1 may be changed according to information on the substrate 120-1 (e.g., a substrate material, a substrate height, etc.), and is not limited to any one numerical value. Further, in the embodiment of the present disclosure, the phase difference of 180 degrees is described as an example, but is not particularly limited to such a phase difference.

It is also important for the phased array antenna 100 to synthesize the signals coming into each antenna 130-1, just as the port-to-port separation is improved to implement the electronic beam steering.

To this end, the slow-wave transmission line 170-2 is added to a front end of the LNA 140-1 into which a signal is input. By adding the slow-wave transmission line 170-2 to the front end of the LNA 140-1, the phased array antenna 100 may perform in-phase combining. At this time, the LNA 140-1 to which the slow-wave transmission line 170-2 is added corresponds to an LNA on a line to which an even-numbered antenna (3) in which the slow-wave transmission line 170-1 is not formed is connected to the port.

Further, the second antenna module 110-2 located just next to and adjacent to the first antenna module 110-1 has a slow-wave transmission line 170-4 located adjacent to an even-numbered antenna (4). As described above, port positions at which the slow-wave transmission line 170 is provided between adjacent antenna modules, that is, the first antenna module 110-1 and the second antenna module 110-2, are configured to be crossed, so that the in-phase combining may be performed with improved inter-port isolation.

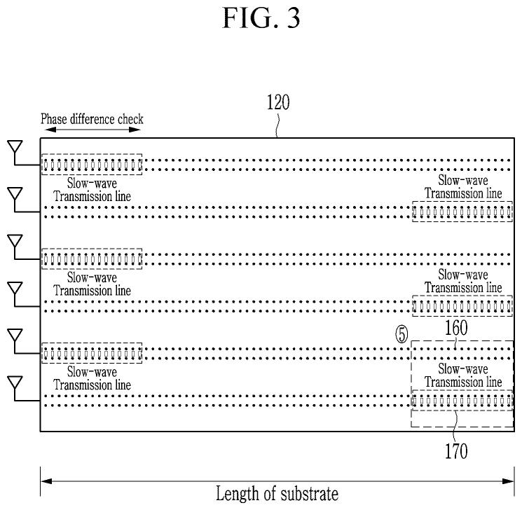

A layout of the substrate 120 in which the above-described structure is implemented and a phase difference simulated using the same will be described with reference to FIGS. 3 to 5.

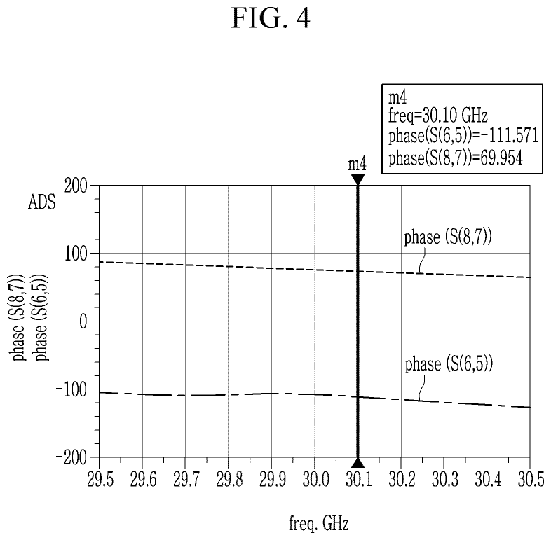

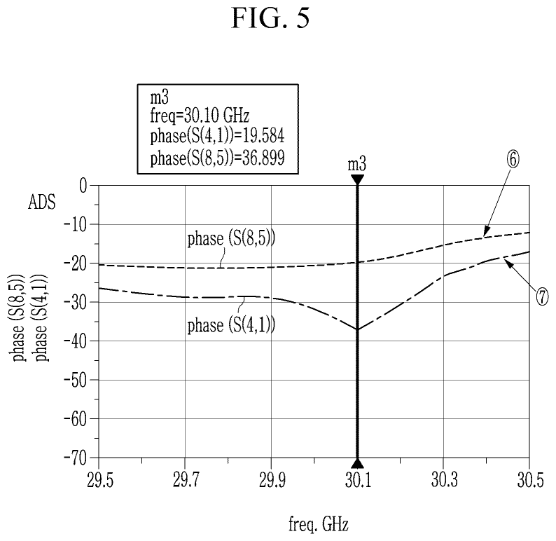

FIG. 3 is an exemplary diagram of a substrate according to an embodiment of the present disclosure. In addition, FIGS. 4 and 5 are exemplary diagrams illustrating simulation results according to an embodiment of the present disclosure.

As illustrated in FIG. 3, in the substrate 120 of the phased array antenna 100 according to the embodiment of the present disclosure for improving the isolation among the ports by using the slow-wave transmission line 170, the slow-wave transmission lines 170 are implemented for each specific port. In the embodiments of the present disclosure, it is described as an example, that the slow-wave transmission line 170 is implemented for each odd-numbered port to which the antenna is connected, and the slow-wave transmission line 170 is implemented at the front end of the LNA 140 in even-numbered ports not including the slow-wave transmission line 170.

In addition, in the embodiment of the present disclosure, a phase difference between the general transmission line 160 and the slow-wave transmission line 170 at a specific position (5) is confirmed by the simulation. As a result of the simulation, it can be seen that, as illustrated in FIG. 4, the phase difference between the general transmission line 160 and the slow-wave transmission line 170 is 180 degrees when the length of the substrate 120 is 10 mm.

In addition, when a case of applying the slow-wave transmission line 170 of FIG. 3 described above and isolation characteristics of the phased array antenna 100 using only the general transmission line 160 are compared with each other, a comparison result is the same as the simulation result of FIG. 5.

As illustrated in FIG. 5, S-parameter characteristics of odd-numbered input ports and even-numbered output ports in the case where the two adjacent transmission lines are transmission lines of (S (4,1)) in the case of the general transmission line 160 are indicated by a first indication means (6). In addition, the S-parameter characteristics of the odd-numbered input ports and the even-numbered output ports in a case where one of the two adjacent transmission lines is the general transmission line 160 and the other one is the slow-wave transmission line 170 (S (8.5)) are indicated by a second indication means (7).

It can be seen that when the slow-wave transmission line 170 is applied to the even-numbered output port according to the embodiment of the present disclosure, the isolation is improved by 17.315 dB compared to the case of using only the general transmission line 160.

In the embodiment of the disclosure, a receiving end of the phased array antenna 100 is mainly illustrated, but the same structure may also be applied to a transmitting end to improve the isolation.

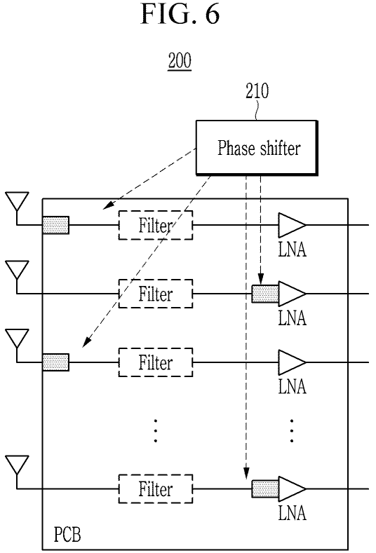

Next, a phased array antenna 200 according to another exemplary embodiment of the present disclosure is described with reference to FIG. 6.

FIG. 6 is an exemplary diagram of a phased array antenna according to another exemplary embodiment of the present disclosure.

As illustrated in FIG. 6, the phased array antenna 200 according to another exemplary embodiment of the present disclosure may improve isolation among ports by adding a phase shifter 210. That is, the phase shifter 210 is used to shift phases of signals input and output between adjacent antennas so as to have a 180-degree phase difference.

Such a phase shifter 210 is used to improve the isolation among the ports of the phased array antenna 200. At this time, a method of causing the phase shifter 210 to shift the phase of the signal is an already known technique, and a detailed description thereof will be omitted in the embodiment of the present disclosure.

That is, since a phase value required for each port varies every situation depending on a directing direction, phase adjustment using the phase shifter 210 is required. It is described as an example that the phase shifter 210 according to the embodiment of the present disclosure adopts a phase shifter of fixed 180 degrees in which separate adjustment need not be required. Through this, the phase shifter 210 may serve as a slow-wave transmission line 160 having a predetermined length.

The drawings referred and the detailed description of the present disclosure disclosed up to now are just used for exemplifying the present disclosure and they are just used for the purpose of describing the present disclosure, but not used for limiting a meaning or restricting the scope of the present disclosure disclosed in the claims. Therefore, it will be appreciated by those skilled in the art that various modifications and other embodiments equivalent thereto can be made therefrom. Accordingly, the true technical scope of the present disclosure should be defined by the technical spirit of the appended claims.

1. A phased array antenna comprising:
a substrate;
a first antenna connected to one side of the substrate, and transmitting or receiving a signal to a first transmission line through a first port;
a second antenna separated from the first antenna by a predetermined spacing, and connected to one side of the substrate, and transmitting or receiving a signal to a second transmission line through a second port; and
a first slow-wave transmission line additionally implemented in the first transmission line of the first port, and generating a phase difference of a specific angle between a phase of the signal transmitted by the first antenna or received through the first antenna, and a phase of the signal transmitted or received through the second transmission line, thereby reducing coupling between the first transmission line and the second transmission line;
wherein the substrate includes a plurality of antennas including the first antenna and the second antenna.
wherein the first slow-wave transmission line is connected to first port of each of 2n−1-th antennas among the plurality of antennas, including the first antenna, and
wherein the first slow-wave transmission line is not connected to the second port of each of 2n-th antennas among the plurality of antennas, including the second antenna.

2. The phased array antenna of claim 1, further comprising:
a first amplifier connected to the first transmission line, and amplifying the signal received from the first antenna or the signal to be transmitted through the first antenna; and
a second amplifier connected to the second transmission line, and amplifying the signal received from the second antenna or the signal to be transmitted through the second antenna.

3. The phased array antenna of claim 2, further comprising:
a second slow-wave transmission line implemented at one side of the second amplifier, and generating a phase difference of a specific angle from a phase of a signal transmitted/received through the first transmission line to which the first amplifier is connected.

4. The phased array antenna of claim 3, wherein:
in-phases of signals input through the first port and the second port are adjusted based on the second slow-wave transmission line.

5. The phased array antenna of claim 1, wherein:
the first slow-wave transmission line is implemented with a length of 10 mm.

6. A phased array antenna comprising:
a first antenna module in which a plurality of first antennas are connected to a substrate through respective ports to transmit and receive signals; and
a second antenna module implemented adjacent to the first antenna module, in which a plurality of second antennas are connected to the substrate through respective ports to transmit and receive signals,
wherein a plurality of slow-wave transmission lines are included in each of the first antenna module and the second antenna module so that a phase difference between the signals transmitted and received through the first antenna module and the second antenna module becomes a specific angle,
wherein the first antenna module includes the slow-wave transmission lines at ports of each of 2n−1-th antennas among the plurality of first antennas, and
wherein the second antenna module does not include the slow-wave transmission lines at ports of each of 2n−1-th antennas among the plurality of second antennas, thereby reducing coupling between the first antenna module and the second antenna module.

7. (canceled)

8. The phased array antenna of claim 6, wherein:
the first antenna module,
includes a plurality of amplifiers connected to a first transmission line, and amplifying the signal received from the plurality of first antennas or the signal to be transmitted through the first antennas, and
the slow-wave transmission lines are provided at one side of amplifiers located at a 2n-th position among the plurality of amplifiers.

9. The phased array antenna of claim 6, wherein:
in the second antenna module,
the slow-wave transmission lines are provided in respective ports of 2n-th antennas among the plurality of second antennas.

10. The phased array antenna of claim 9, wherein:
the second antenna module,
includes a plurality of amplifiers connected to a second transmission line, and amplifying the signal received from the plurality of second antennas or the signal to be transmitted through the second antennas, and
the slow-wave transmission lines are provided at one side of amplifiers located at a 2n−1-th position among the plurality of amplifiers.

11-12. (canceled)
